(19) United States
(12) Patent Application Publication
(10) Pub. No.: US 2025/0203337 A1
(43) Pub. Date: Jun. 19, 2025

(54) BALANCED POWER-LATENCY ADVERTISEMENTS FOR MOBILE COMPUTING DEVICE DISCOVERABILITY

(71) Applicant: Google LLC, Mountain View, CA (US)

(72) Inventors: Sumukh A Shevde, Encinitas, CA (US); Meghana Sahasrabudhe, San Jose, CA (US)

(21) Appl. No.: 18/541,642

(22) Filed: Dec. 15, 2023

(51) Int. Cl. H04W 8/00

(52) U.S. Cl. CPC H04W 8/005

(57) ABSTRACT

Balanced power-latency advertisements for mobile computing devices allow a mobile computing device to be discovered by a remote device at low latency and without excessive power consumption. The mobile computing device determines, based on the wireless signals received from the remote device, a distance between the mobile computing device and the remote device. Responsive to determining whether the distance satisfies a threshold distance, the mobile computing device transmits the wireless advertisement signals at greater rate. The wireless advertisement signals identify the mobile computing device to the remote device causing the remote device to discover the mobile computing device.

### BACKGROUND

A mobile computing device may communicate with one or more remote devices to provide services to a user that may not be possible with the computing device alone. For example, a remote device may include hardware that is unavailable at the mobile computing device or provide services the mobile computing device is incapable of. Mobile computing devices may accordingly be enhanced by features of remote devices.

### SUMMARY

In general, aspects of the techniques of this disclosure are directed to balanced power-latency advertisements for device discovery. Mobile computing devices may advertise their presence by transmitting wireless advertisement signals to cause remote devices to discover the mobile computing devices. Transmission of each wireless advertisement signal consumes limited power resources (e.g., battery resources) of the mobile computing device. Increasing a rate of transmission of wireless advertisement signals may reduce the latency at which a remote device can discover a mobile computing device at the cost of reduced battery life. Decreasing a rate of transmission may benefit battery life at the cost of increasing the latency at which a remote device can discover a mobile computing device.

Some solutions transmit wireless advertisement signals at a constant rate, which may be set to provide acceptable latency and power consumption in a general sense. For example, transmitting wireless advertisement signals every 1.28 seconds(s) allows advertisement with minimal power consumption, but may result in significant latency (e.g., approximately 6 s) for computing device discovery. Greater latency may be experienced as delay or unresponsiveness when a user attempts to operate or use a remote device.

In accordance with the techniques disclosed herein, rather than transmitting wireless advertisement signals at a high constant rate (e.g., every 100 milliseconds (ms)), which may cause a mobile computing device to consume excessive power, or a low constant rate (e.g., every 1.28 s), which may cause a mobile computing device to be discovered at a high latency (e.g., 6.5 s), a mobile computing device may determine a distance to a remote device, and transmit wireless advertisement signals at a rate based on the distance. In this manner, a mobile computing device may transmit wireless advertisement signals in a power-latency balanced manner such that the mobile computing device may be discovered with low latency (e.g., ≤1.5 s) while avoiding excessive power consumption.

In some aspects, the techniques described herein relate to a method including transmitting, by a computing device, one or more wireless advertisement signals at a first rate; receiving, by the computing device, one or more wireless signals emitted from a remote device; determining, by the computing device and based on the one or more wireless signals received from the remote device, a distance between the computing device and the remote device; determining, by the computing device, whether the distance satisfies a threshold distance; and responsive to determining the distance satisfies the threshold distance, transmitting the one or more wireless advertisement signals at a second rate greater than the first rate, wherein the one or more wireless advertisement signals identify the computing device to the remote device.

In some aspects, the techniques described herein relate to a computing device including a memory that stores instructions; and one or more processors that execute the instructions to: transmit one or more wireless advertisement signals at a first rate; receive one or more wireless signals emitted from a remote device; determine based on the one or more wireless signals received from the remote device, a distance between the computing device and the remote device; determine whether the distance satisfies a threshold distance; and responsive to determining the distance satisfies the threshold distance, transmit the one or more wireless advertisement signals at a second rate greater than the first rate, wherein the one or more wireless advertisement signals identify the computing device to the remote device.

In some aspects, the techniques described herein relate to a non-transitory computer-readable storage medium including instructions, that when executed by one or more processors of a computing device, cause the one or more processors to: transmit one or more wireless advertisement signals at a first rate; receive one or more wireless signals emitted from a remote device; determine based on the one or more wireless signals received from the remote device, a distance between the computing device and the remote device; determine whether the distance satisfies a threshold distance; and responsive to determining the distance satisfies the threshold distance, transmit the one or more wireless advertisement signals at a second rate greater than the first rate, wherein the one or more wireless advertisement signals identify the computing device to the remote device.

The details of one or more examples of the subject matter of this specification are set forth in the accompanying drawings and the description below. Other features, aspects, and advantages of the subject matter will become apparent from the description, the drawings, and the claims.

### BRIEF DESCRIPTION OF DRAWINGS

FIG. 1 is a conceptual diagram illustrating an example environment for balanced power-latency advertisements for mobile computing device discovery, in accordance with one or more aspects of the present disclosure.

FIG. 2 is a conceptual diagram illustrating an example environment for balanced power-latency advertisements for mobile computing device discovery, in accordance with one or more aspects of the present disclosure.

FIG. 3 is a flowchart of an example process for balanced power-latency advertisements for mobile computing device discovery, in accordance with one or more aspects of the present disclosure.

### DETAILED DESCRIPTION

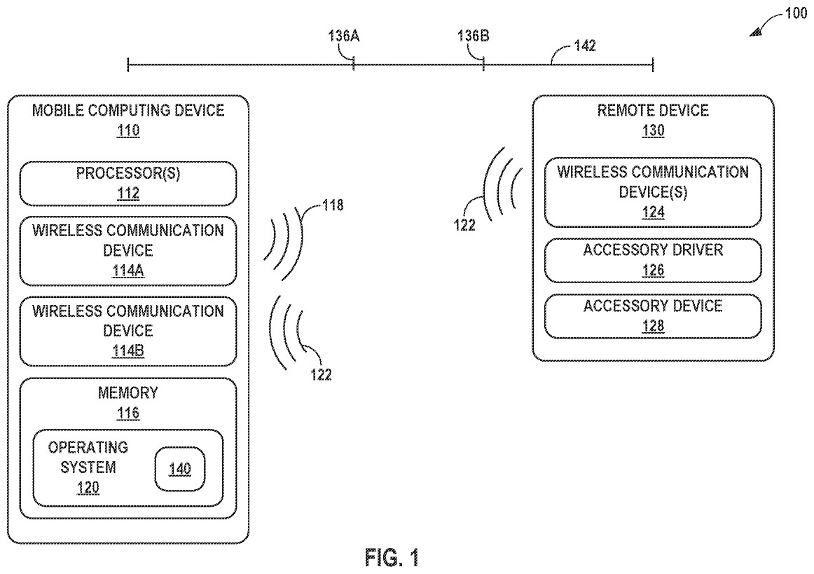

FIG. 1 is a conceptual diagram illustrating an example environment for balanced power-latency advertisements for mobile computing device discovery, in accordance with one or more aspects of the present disclosure. As can be seen, environment 100 includes a mobile computing device 110 and a remote device 130.

Mobile computing device 110 may be an example of a mobile phone, a tablet computer, a laptop computer, a wearable device, a gaming system, a media player, an e-book reader, or any other type of portable or wearable computing device may be discovered by remote device 130. FIG. 1 illustrates a particular example of mobile computing device 110, and many other examples of mobile computing device 110 may be used in other instances and may include a subset of the components included in example mobile computing device 110 or may include additional components not shown in FIG. 1.

In some examples, mobile computing device 110 includes one or more processors 112, one or more wireless communication devices 114, and memory 116. Memory 116 of computing device 110 may include operating system 120, which may provide an execution environment for an advertisement module 140 whereby, as will be described herein, advertisement module 140 provides balanced power-latency advertisements in accordance with the techniques disclosed herein.

For example, advertisement module 140 may cause mobile computing device 110 to transmit one or more wireless advertisement signals 118. Wireless advertisement signals 118 may cause remote device 130 to discover mobile computing device 110 and cause remote device 130 to enable or allow operation of one or more features of remote device 130. For example, remote device 130 may discover mobile computing device 110 by receiving wireless advertisement signal 118 from mobile computing device 110. Remote device 130 may comprise one or more accessory devices 128 that may be controlled by an accessory driver 126 (e.g., software or firmware driver). In some examples, accessory driver 126 may comprise one or more instructions stored on computer-readable storage media and executable by remote device 130, such as a processor thereof.

Remote device 130 may be an example of various peripherals or equipment having some functionality enabled via discovery and/or communication with mobile computing device 110. For example, remote device 130 may comprise a smart door lock, vehicle lock, fitness or exercise equipment, or a motorized servo or actuator that may only become operable upon at least the discovery, and in some cases authentication, of mobile computing device 110. For instance, accessory device 128 may be a motorized lock mechanism for a vehicle or building door that unlocks after remote device 130 discovers and authenticates mobile computing device 110.

Reducing the latency at which remote device 130 discovers mobile computing device 110 is generally desirable in increasing the responsiveness of accessory device 128. With physical keys, a user may immediately insert a physical key into a lock to unlock and open a vehicle or building door. In contrast, with some systems, a digital or wireless key may have a latency of several seconds (e.g., 6.5 s) where the user is waiting for the door to unlock. This may cause the user to believe accessory device 128 of remote device 130 is not functioning correctly.

Table 1 below illustrates some examples of median latency for discovery and power consumption (e.g., battery utilization) for an example set of 90^{th} percentile and 70^{th} percentile mobile computing devices 110 while transmitting wireless advertisement signals 118 at various rates. Power consumption is shown in terms of battery life reduction in hours (“h”) over the course of a day (e.g., a 24 h period).

TABLE 1

| | Wearable | Wearable | Portable | Portable | Median |
|---|---|---|---|---|---|
| | Device (90%) | Device (70%) | Device (90%) | Device (70%) | Latency |
| 100 ms | −0.22 h | −0.54 h | −0.17 h | −0.42 h | 1486 ms |
| 240 ms | −0.09 h | −0.23 h | −0.07 h | −0.17 h | 2303 ms |
| 640 ms | −0.03 h | −0.09 h | −0.03 h | −0.06 h | 4277 ms |
| 1.28 s | −0.01 h | −0.02 h | −0.01 h | −0.01 h | 6531 ms |

To illustrate, at a transmission interval of 100 ms, the median latency may be approximately 1.5 s with relatively high power consumption. As shown for example, at the transmission interval of 100 ms, battery life is reduced by 0.22 h for a 90^{th} percentile wearable mobile computing device 110 (e.g., a watch) and by a larger 0.54 h for a 70^{th} device, both over the course of a day. As another example, a portable mobile computing device 110 (e.g., a smart phone, tablet, or laptop) transmitting at a transmission interval of 100 ms may see battery life reduced by 0.17 h and 0.42 h for 90^{th} percentile and 70^{th} percentile devices, respectively. In contrast, a transmission interval of 1.28 s has relatively low power consumption (e.g., 0.01-0.02 h) and a median latency of approximately 6.5 s.

In accordance with the techniques disclosed herein, advertisement module 140 may provide low latency device discovery while preserving battery life. For example, advertisement module 140 may modulate or adjust the rate at which wireless advertisement signals 118 are transmitted, rather than transmitting at a high, low, or other fixed rate. In some examples, advertisement module 140 may determine a distance 142 between mobile computing device 110 and remote device 130 and adjust the rate at which wireless advertisement signals 118 are transmitted based on distance 142.

Advertisement module 140 may determine distance 142 between mobile computing device 110 and remote device 130 based on one or more signal strength, power level, or other characteristics of one or more wireless signals 122 transmitted by remote device 130. For example, advertisement module 140 may determine distance 142 between mobile computing device 110 and remote device 130 based on a received signal strength indicator (RSSI), decibels (dB) of wireless signals 122.

Remote device 130 may be transmitting wireless signals 122 as part of communication with various devices, including or excluding mobile computing device 110. For example, remote device 130 may transmit wireless signals 122, such as via a wireless communication device 124, in communicating with mobile computing device 110 or other devices directly or via a wireless network. In either case, mobile computing device 110 may receive wireless signals 122 emitted from remote device 130, such as at wireless communication device 114. Advertisement module 140 may then determine distance 142 between mobile computing device 110 and remote device 130 using one or more characteristics of wireless signals 122, such as an RSSI thereof.

Memory 116 may store one or more threshold distances 136. The example of FIG. 1 illustrates example threshold distances 136A and 136B. In some examples, advertisement module 140 may adjust a transmission rate of wireless advertisement signals 118 based on whether threshold distance 136 is satisfied by distance 142 between mobile computing device 110 and remote device 130. Advertisement module 140 may adjust the transmission rate based on a particular threshold distance 136 that is satisfied. In some examples, each threshold distance 136 may have a matching transmission rate, which may be stored in memory 116.

For example, at distance 142, such as 200 ft or more, advertisement module 140 may cause wireless communication device 114 to transmit at a rate of one wireless advertisement signal 118 every 1.28 s (e.g., a transmission interval of 1.28 s). When distance 142 between mobile computing device 110 and remote device 130 satisfies threshold distance 136A, advertisement module 140 may change the transmission rate. For example, when distance 142 between mobile computing device 110 and remote device 130 is less than threshold distance 136A of 200 ft, advertisement module 140 may increase the transmission rate at which wireless communication device transmits wireless advertisement signals 118 via wireless communication device 114, such as to a transmission interval of 640 ms (e.g., one wireless advertisement signal 118 every 640 ms). When distance 142 satisfies threshold distance 136B of 10 ft, for example, advertisement module 140 may further increase the transmission rate, such as to a transmission interval of 100 ms (e.g., one wireless advertisement signal 118 every 100 ms).

As can be seen, advertisement module 140 may increase transmission rate as a mobile computing device 110 moves closer to remote device 130. In this manner, when a user arrives at remote device 130, accessory device 128 of remote device 130 may be enabled with little latency (e.g., less than 1.5 s median latency). The user accordingly experiences immediate or nearly immediate response from remote device 130 as the user arrives at remote device 130. For example, when the user arrives at remote device 130, an accessory device 128 comprising a lock mechanism may already be unlocked or in the process of unlocking, allowing the user to open a door thereof with little or no delay.

Advertisement module 140 may authenticate mobile computing device 110 with remote device 130, such as to enable protected functionality (e.g., functionality requiring authentication) at remote device 130. For example, mobile computing device 110 may transmit authentication information comprising an authentication token or identifier to remote device 130 if remote device 130 requests or requires authentication before enabling protected functionality. An authentication token or identifier may be a cryptographic hash or string in some embodiments.

As shown in the example of FIG. 1, mobile computing device 110 may comprise one or more wireless communication devices 114. One or more wireless communication devices 114 of mobile computing device 110 may communicate with external devices via one or more wireless networks by transmitting and/or receiving network signals on the one or more networks. Examples of one or more wireless communication devices 114 include an audio transceiver, an optical transceiver, a radio frequency transceiver, or any other type of device that can wirelessly send and/or receive information. Other examples of one or more wireless communication devices 114 may include short wave radios, cellular data radios (e.g., LTE radios), wireless network radios (e.g., WIFI radios), and low energy radios (e.g., BLUETOOTH/BLUETOOTH LE radios).

In some examples, mobile computing device 110 may comprise a first wireless communication device 114A and a second wireless communication device 114B. First wireless communication device 114A and second wireless communication device 114B may comprise distinct radios that transmit and/or receive distinct wireless signals with distinct power consumption levels. For example, first wireless communication device 114A may comprise a lower power radio, such as a BLUETOOTH radio, and second wireless communication device 114B may comprise a higher power radio, such as a WIFI or LTE radio.

Mobile computing device 110 may transmit wireless advertisement signals 118 through first wireless communication device 114A and receive wireless signals 122 from remote device through second wireless communication device 114B in some examples. Though shown in the example of FIG. 1 as including two wireless communication devices 114, in various aspects of the disclosed techniques, mobile communication device 110 may comprise fewer or additional wireless communication devices 114. For example, mobile computing device 110 may comprise a single wireless communication device 114 that both transmits wireless advertisement signals 118 and receives wireless signals 122 from remote device 130.

One or more processors 112 may implement functionality and/or execute instructions within mobile computing device 110. For example, one or more processors 112 in mobile computing device 110 may receive and execute instructions stored in memory 116 that execute the functionality of operating system 120 and advertisement module 140. The instructions executed by one or more processors 112 may cause computing device 110 to store information within memory 116 during program execution.

Examples of one or more processors 112 include application processors, display controllers, sensor hubs, processing circuitry, and any other hardware configured to function as a processing unit. One or more processors 112 may execute instructions of operating system 120 and advertisement module 140 to perform actions or functions. That is, operating system 120 and advertisement module 140 may be operable by one or more processors 112 to perform various actions or functions of computing device 110.

Memory 116 within computing device 110 may store information for processing during operation of computing device 110. That is, computing device 110 may store data accessed by operating system 120 and advertisement module 140 during execution at computing device 110, including, for example, distance thresholds 136. In some examples, memory 116 is a temporary memory, meaning that a primary purpose of memory 116 is not long-term storage. Memory 116 on computing device 110 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Memory 116, in some examples, may include one or more computer-readable storage media. Memory 116 may be configured to store larger amounts of information than volatile memory. Memory 116 may be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Memory 116 may store program instructions and/or information (e.g., data) associated with operating system 120 and advertisement module 140. Advertisement module 140 may execute at one or more processors 112 to perform functions of advertisement module 140.

Communication channels may interconnect each of the components 112, 114, 116 for inter-component communications (physically, communicatively, and/or operatively). In some examples, communication channels may include a system bus, a network connection, an inter-process communication data structure, or any other method for communicating data.

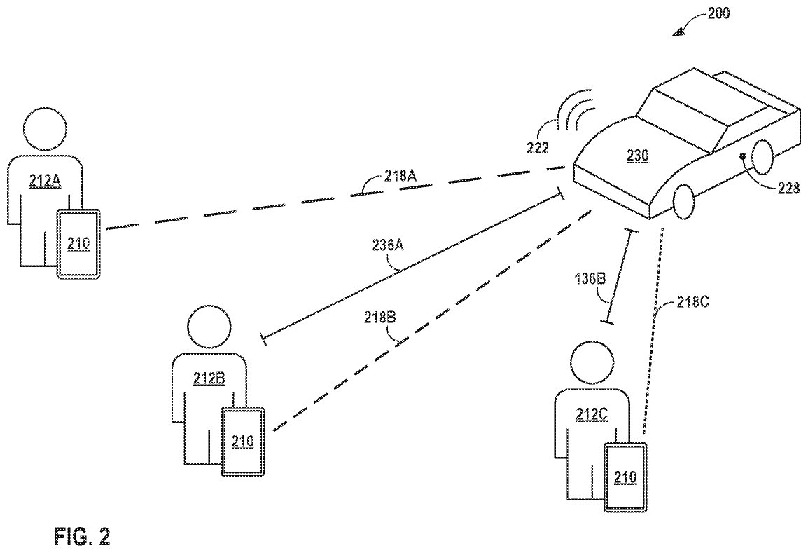

FIG. 2 is a conceptual diagram illustrating an example environment for balanced power-latency advertisements for mobile computing device discovery, in accordance with one or more aspects of the present disclosure. Mobile computing device 210 and remote device 230 of FIG. 2 are described below as examples of computing device 110 and remote device 130 as illustrated in FIG. 1.

As shown in the example of FIG. 2, mobile computing device 210 may be carried by or worn by user 212 as user moves in environment 200. For instance, user 212A-212C represents user 212 at different distances relative to remote device 230 in environment 200.

Mobile computing device 210 may receive wireless signals 222 transmitted by remote device 230 to determine a distance between mobile computing device 210 and remote device 230. Mobile computing device 210 may compare the distance to one or more threshold distances 236 and change a transmission rate of wireless advertisement signals 218 based on the comparison. As described above, mobile computing device 210 may cause remote device 130 to discover mobile computing device 210 through the transmission of wireless advertisement signals 218.

In some examples, when mobile computing device 210 determines a distance between remote device 130 and mobile computing device 210 is beyond any threshold distance 236 (e.g., more than 200 ft), mobile computing device 210 may transmit wireless advertisement signals 218 at a first rate, which may be a default transmission rate. As shown by user 212A for example, mobile computing device 210 may be beyond threshold distances 236A and 236B. As such, mobile computing device 210 may transmit wireless advertisement signals 218A at a first rate or default rate (e.g., at a 1.28 s transmission interval). The first rate may be a relatively low rate (e.g., a 1.28 s transmission interval) to reduce power consumption and accordingly may have a high latency at which remote device 230 may discover mobile computing device 210 (e.g., a median latency of 6.5 s).

As shown by user 212B, mobile computing device 210 may move closer to remote device 230 (e.g., within 200 ft), such as to satisfy (e.g., be within) threshold distance 236A. In such case, mobile computing device 210 may change the transmission rate of wireless advertisement signals 218, such as to a transmission rate associated with or matching threshold distance 236A. In the example of FIG. 2 for instance, mobile computing device 210 at the location of user 212B may transmit wireless advertisement signals 218B at an increased transmission rate (e.g., at a transmission interval of 640 ms), which lowers latency at which remote device 230 may discover mobile computing device 210 (e.g., a median latency of 4 s).

As shown by user 212C, mobile computing device 210 may move closer to remote device 230 (e.g., within 10 ft), such as to satisfy threshold distance 236B. Mobile computing device may change the transmission rate of wireless advertisement signals 218 based on threshold distance 236B. In the example of FIG. 2 for instance, mobile computing device 210 may transmit wireless advertisement signals 218C at an increased transmission rate (e.g., at a transmission interval of 100 ms), which may lower the latency at which remote device 230 can discover mobile computing device 210 (e.g., a median latency of 1.5 s).

In this manner, as user 212 arrives at remote device 130, mobile computing device 210 may have already or may quickly (e.g., within 1.5 s) cause remote device 230 to discover mobile computing device 210. Mobile computing device 210 can then authorize or authenticate with remote device 230, allowing user 212 to use accessory device 228 of remote device 230 immediately or nearly immediately (e.g., within 1.5 s). With respect to FIG. 2 for example, mobile computing device 210 may cause discovery by and authorize a vehicle (e.g., remote device 230) to unlock a door (e.g., accessory device 228) allowing user 212 to open the door immediately or nearly immediately after (e.g., within 1.5 s) user 212 arrives at the vehicle.

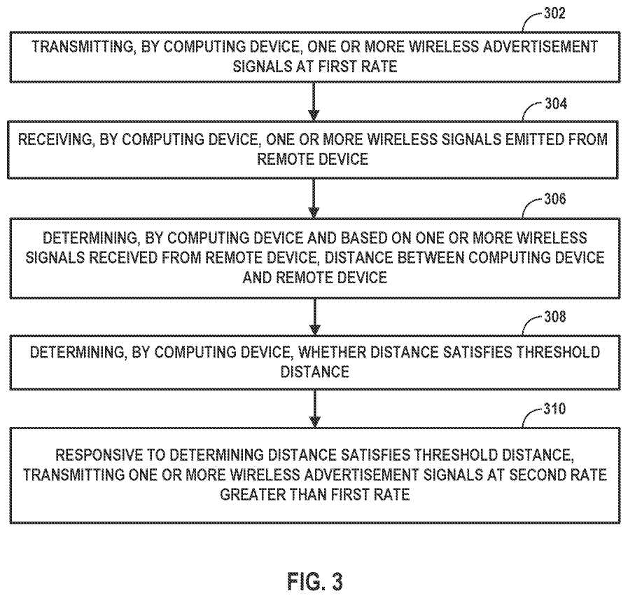

FIG. 3 is a flowchart of an example process for balanced power-latency advertisements for mobile computing device discovery, in accordance with one or more aspects of the present disclosure. FIG. 3 is described in the context of FIG. 1.

In some examples, mobile computing device 110 may transmit one or more wireless advertisement signals 118 at a first rate (302). For instance, mobile computing device 110 may transmit one or more wireless advertisement signals 118, such as through wireless communication device 114, at a transmission rate of one wireless advertisement signal 118 every 1.28 s. Wireless advertisement signals 118 may identify mobile computing device 110 to remote device 130, such as to cause remote device 130 to discover mobile computing device 110.

Mobile computing device 110 may receive one or more wireless signals 122 emitted (e.g., transmitted) from remote device 130 (304). Mobile computing device 110 may determine, based on the wireless signals 122 from remote device 130, distance 142 between mobile computing device 110 and remote device 130 (306). For example, mobile computing device 110 may utilize RSSI or dB of wireless signals 122 to determine distance 142.

In some examples, mobile computing device 110 may transmit wireless advertisement signals 118 with a first radio (e.g., wireless communication device 114A) of mobile computing device 110 and receive wireless signals 122 with a second radio (e.g., wireless communication device 114B) of mobile computing device 110.

Mobile computing device 110 may determine whether distance 142 satisfies a threshold distance 136 (308). For example, mobile computing device 110 may compare distance 142 to the values of threshold distances 136A and 136B. For instance, threshold distance 136A may be 200 ft and may be satisfied when distance 142 is less than 200 ft, and distance threshold 136B may be 10 ft and be satisfied when distance 142 is less than 10 ft.

In response to determining distance 142 satisfies threshold distance 136, mobile computing device 110 may transmit wireless advertisement signals 118 a second rate greater than the first rate (310). For example, mobile computing device 110 may transmit wireless advertisement signals 118 at a second rate of one wireless advertisement signal 118 every 50 ms to 700 ms (e.g., 640 ms), whereas the first rate may be at a lower rate, such as one wireless advertisement signal every 1 s to 2 s (e.g., 1.28 s).

Mobile computing device 110 may adjust the second rate in some examples, such as to further reduce discovery latency. For example, mobile computing device 110 may determine distance 142 further decreased to satisfy threshold distance 136B that is closer to remote device 130 than threshold distance 136A. Responsive to determining the distance decreased to satisfy threshold distance 136B, mobile computing device 110 may increase the second rate, such as to a transmission rate of one wireless advertisement signal 118 every 100 ms, versus every 640 ms for example for threshold distance 136A, to further lower discovery latency.

In some examples, mobile computing device 110 may determine the distance between mobile computing device 110 and remote device 130 has not changed for a period of time (e.g., 15 minutes), which may indicate that a user does not currently intend to use accessory device 128 of remote device 130. As such transmission rate may be lowered to conserve power. For example, mobile computing device 110 may determine distance 142 is within a range including threshold distance 136 for more than a predefined period of time, and in response, discontinue transmission of wireless advertisement signals 118 at the second rate (e.g., a transmission interval of 640 ms) to transmit the wireless advertisement signals at the first rate (e.g., a transmission interval of 1.28 s), such as to reduce power consumption.

As described above, wireless advertisement signals 118 may identify mobile computing device 110 to remote device 130 causing remote device 130 to discover mobile computing device 110. In some examples, responsive to identification by remote device 130, mobile computing device 110 may receive a request for authentication information from remote device 130 to enable functionality requiring authentication (e.g., a protected function) of remote device 130. For example, actuation (e.g., locking or unlocking) of a lock mechanism (e.g., accessory device 128) may be a protected function and therefore require authentication before the lock mechanism may be rotated or moved to a locked or unlocked position.

Mobile computing device 110 may transmit authentication information, such as through wireless communication device 114, to remote device 130 in response to the request. For example, mobile computing device 110 may transmit an authorization token or other identifier to remote device 130. Operating system 120 may generate, store, and retrieve the authorization token or identifier such as from memory 116. As described above, an authentication token or identifier may be a cryptographic token or string in some examples.

Example 1: A method includes transmitting, by a computing device, one or more wireless advertisement signals at a first rate; receiving, by the computing device, one or more wireless signals emitted from a remote device; determining, by the computing device and based on the one or more wireless signals received from the remote device, a distance between the computing device and the remote device; determining, by the computing device, whether the distance satisfies a threshold distance; and responsive to determining the distance satisfies the threshold distance, transmitting the one or more wireless advertisement signals at a second rate greater than the first rate, wherein the one or more wireless advertisement signals identify the computing device to the remote device.

Example 2: The method of example 1, further includes responsive to identification by the remote device, receiving, by the computing device, a request for authentication information from the remote device to enable a protected function of the remote device.

Example 3: The method of example 1, further includes determining the distance is within a range including the threshold distance for more than a predefined period of time; responsive to determining the distance is within the range including the threshold distance for more than the predefined period of time, discontinuing transmission of the one or more wireless advertisement signals at the second rate and transmitting the one or more wireless advertisement signals at the first rate.

Example 4: The method of example 1, wherein the threshold distance is a first threshold distance, the method further includes determining the distance decreased to satisfy a second threshold distance less than the first threshold distance; and responsive to determining the distance decreased to satisfy the second threshold distance, increasing the second rate.

Example 5: The method of example 1, wherein the one or more wireless advertisement signals are transmitted with a first radio of the computing device and the one or more wireless signals are received with a second radio of the computing device.

Example 6: The method of example 5, wherein the first radio is a lower power radio than the second radio.

Example 7: The method of example 1, wherein the first rate has a transmission interval of between 1 second and 2 seconds.

Example 8: The method of example 7, wherein the second rate has a transmission interval of between 50 milliseconds and 700 milliseconds to reduce a latency at which the remote accessory device identifies the computing device relative to the first rate.

Example 9: A computing device includes a memory that stores instructions; and one or more processors that execute the instructions to: transmit one or more wireless advertisement signals at a first rate; receive one or more wireless signals emitted from a remote device; determine based on the one or more wireless signals received from the remote device, a distance between the computing device and the remote device; determine whether the distance satisfies a threshold distance; and responsive to determining the distance satisfies the threshold distance, transmit the one or more wireless advertisement signals at a second rate greater than the first rate, wherein the one or more wireless advertisement signals identify the computing device to the remote device.

Example 10: The computing device of example 9, wherein the one or more processors further execute the instructions to: responsive to identification by the remote device, receive a request for authentication information from the remote device to enable a protected function of the remote device.

Example 11: The computing device of example 9, wherein the one or more processors further execute the instructions to: determine the distance is within a range including the threshold distance for more than a predefined period of time; responsive to determining the distance is within the range including the threshold distance for more than the predefined period of time, discontinue transmission of the one or more wireless advertisement signals at the second rate and transmit the one or more wireless advertisement signals at the first rate.

Example 12: The computing device of example 9, wherein the threshold distance is a first threshold distance and the one or more processors further execute the instructions to: determine the distance decreased to satisfy a second threshold distance less than the first threshold distance; and responsive to determining the distance decreased to satisfy the second threshold distance, increase the second rate.

Example 13: The computing device of example 9, wherein the one or more wireless advertisement signals are transmitted with a first radio of the computing device and the one or more wireless signals are received with a second radio of the computing device.

Example 14: The computing device of example 13, wherein the first radio is a lower power radio than the second radio.

Example 15: The computing device of example 9, wherein the first rate has a transmission interval of between 1 second and 2 seconds.

Example 16: The computing device of example 15, wherein the second rate has a transmission interval of between 50 milliseconds and 700 milliseconds to reduce a latency at which the remote accessory device identifies the computing device relative to the first rate.

Example 17: A non-transitory computer-readable storage medium includes instructions, that when executed by one or more processors of a computing device, cause the one or more processors to: transmit one or more wireless advertisement signals at a first rate; receive one or more wireless signals emitted from a remote device; determine based on the one or more wireless signals received from the remote device, a distance between the computing device and the remote device; determine whether the distance satisfies a threshold distance; and responsive to determining the distance satisfies the threshold distance, transmit the one or more wireless advertisement signals at a second rate greater than the first rate, wherein the one or more wireless advertisement signals identify the computing device to the remote device.

Example 18: The non-transitory computer-readable storage medium of example 17, wherein the one or more processors further execute the instructions to: responsive to identification by the remote device, receive a request for authentication information from the remote device to enable a protected function of the remote device.

Example 19: The non-transitory computer-readable storage medium of example 17, wherein the one or more processors further execute the instructions to: determine the distance is within a range including the threshold distance for more than a predefined period of time; responsive to determining the distance is within the range including the threshold distance for more than the predefined period of time, discontinue transmission of the one or more wireless advertisement signals at the second rate and transmit the one or more wireless advertisement signals at the first rate.

Example 20: The non-transitory computer-readable storage medium of example 17, wherein the threshold distance is a first threshold distance and the one or more processors further execute the instructions to: determine the distance decreased to satisfy a second threshold distance less than the first threshold distance; and responsive to determining the distance decreased to satisfy the second threshold distance, increase the second rate.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise random-access memory (RAM), read-only memory (ROM), EEPROM, compact disc read-only memory (CD-ROM) or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of a computer-readable medium.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structures suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of inter-operative hardware units, including one or more processors as described above, in conjunction with suitable software and/or firmware.

Various embodiments have been described. These and other embodiments are within the scope of the following claims.

What is claimed is:

1. A method comprising:
transmitting, by a computing device, one or more wireless advertisement signals at a first rate;
receiving, by the computing device, one or more wireless signals emitted from a remote device;
determining, by the computing device and based on the one or more wireless signals received from the remote device, a distance between the computing device and the remote device;
determining, by the computing device, whether the distance satisfies a threshold distance; and
responsive to determining the distance satisfies the threshold distance, transmitting the one or more wireless advertisement signals at a second rate greater than the first rate, wherein the one or more wireless advertisement signals identify the computing device to the remote device.

2. The method of claim 1, further comprising:
responsive to identification by the remote device, receiving, by the computing device, a request for authentication information from the remote device to enable a protected function of the remote device.

3. The method of claim 1, further comprising:
determining the distance is within a range including the threshold distance for more than a predefined period of time; and
responsive to determining the distance is within the range including the threshold distance for more than the predefined period of time, discontinuing transmission of the one or more wireless advertisement signals at the second rate and transmitting the one or more wireless advertisement signals at the first rate.

4. The method of claim 1, wherein the threshold distance is a first threshold distance, the method further comprising:
determining the distance decreased to satisfy a second threshold distance less than the first threshold distance; and
responsive to determining the distance decreased to satisfy the second threshold distance, increasing the second rate.

5. The method of claim 1, wherein the one or more wireless advertisement signals are transmitted with a first radio of the computing device and the one or more wireless signals are received with a second radio of the computing device.

6. The method of claim 5, wherein the first radio is a lower power radio than the second radio.

7. The method of claim 1, wherein the first rate has a transmission interval of between 1 second and 2 seconds.

8. The method of claim 7, wherein the second rate has a transmission interval of between 50 milliseconds and 700 milliseconds to reduce a latency at which the remote device identifies the computing device relative to the first rate.

9. A computing device comprising:
a memory that stores instructions; and
one or more processors that execute the instructions to:
transmit one or more wireless advertisement signals at a first rate;
receive one or more wireless signals emitted from a remote device;
determine based on the one or more wireless signals received from the remote device, a distance between the computing device and the remote device;
determine whether the distance satisfies a threshold distance; and
responsive to determining the distance satisfies the threshold distance, transmit the one or more wireless advertisement signals at a second rate greater than the first rate, wherein the one or more wireless advertisement signals identify the computing device to the remote device.

10. The computing device of claim 9, wherein the one or more processors further execute the instructions to:
responsive to identification by the remote device, receive a request for authentication information from the remote device to enable a protected function of the remote device.

11. The computing device of claim 9, wherein the one or more processors further execute the instructions to:
determine the distance is within a range including the threshold distance for more than a predefined period of time; and
responsive to determining the distance is within the range including the threshold distance for more than the predefined period of time, discontinue transmission of the one or more wireless advertisement signals at the second rate and transmit the one or more wireless advertisement signals at the first rate.

12. The computing device of claim 9, wherein the threshold distance is a first threshold distance and the one or more processors further execute the instructions to:
determine the distance decreased to satisfy a second threshold distance less than the first threshold distance; and
responsive to determining the distance decreased to satisfy the second threshold distance, increase the second rate.

13. The computing device of claim 9, wherein the one or more wireless advertisement signals are transmitted with a first radio of the computing device and the one or more wireless signals are received with a second radio of the computing device.

14. The computing device of claim 13, wherein the first radio is a lower power radio than the second radio.

15. The computing device of claim 9, wherein the first rate has a transmission interval of between 1 second and 2 seconds.

16. The computing device of claim 15, wherein the second rate has a transmission interval of between 50 milliseconds and 700 milliseconds to reduce a latency at which the remote device identifies the computing device relative to the first rate.

17. A non-transitory computer-readable storage medium comprising instructions, that when executed by one or more processors of a computing system, cause the one or more processors to:
transmit one or more wireless advertisement signals at a first rate;
receive one or more wireless signals emitted from a remote device;
determine based on the one or more wireless signals received from the remote device, a distance between the computing system and the remote device;
determine whether the distance satisfies a threshold distance; and
responsive to determining the distance satisfies the threshold distance, transmit the one or more wireless advertisement signals at a second rate greater than the first rate, wherein the one or more wireless advertisement signals identify the computing system to the remote device.

18. The non-transitory computer-readable storage medium of claim 17, wherein the one or more processors further execute the instructions to:
responsive to identification by the remote device, receive a request for authentication information from the remote device to enable a protected function of the remote device.

19. The non-transitory computer-readable storage medium of claim 17, wherein the one or more processors further execute the instructions to:
determine the distance is within a range including the threshold distance for more than a predefined period of time; and
responsive to determining the distance is within the range including the threshold distance for more than the predefined period of time, discontinue transmission of the one or more wireless advertisement signals at the second rate and transmit the one or more wireless advertisement signals at the first rate.

20. The non-transitory computer-readable storage medium of claim 17, wherein the threshold distance is a first threshold distance and the one or more processors further execute the instructions to:
determine the distance decreased to satisfy a second threshold distance less than the first threshold distance; and
responsive to determining the distance decreased to satisfy the second threshold distance, increase the second rate.
